(19) United States
(12) Patent Application Publication
(10) Pub. No.: US 2013/0181054 A1
(43) Pub. Date: Jul. 18, 2013

(54) SYSTEM AND METHOD FOR PROCESSING BAR-CODE ENABLED CARDS

(71) Applicants: Chris Juarez Durham, Santa Clara, UT (US); John Fenwick Graf, Santa Clara, UT (US); Ryan Connell Durham, Santa Clara, UT (US)

(72) Inventors: Chris Juarez Durham, Santa Clara, UT (US); John Fenwick Graf, Santa Clara, UT (US); Ryan Connell Durham, Santa Clara, UT (US)

(21) Appl. No.: 13/543,737

(22) Filed: Jul. 6, 2012

Related U.S. Application Data
(60) Provisional application No. 61/504,720, filed on Jul. 6, 2011.

(51) Int. Cl. G06K 7/10

(52) U.S. Cl. CPC G06K 7/10544
USPC 235/462.41

(57) ABSTRACT

Disclosed herein are systems, methods, and non-transitory computer-readable storage media for capturing images of barcode enabled loyalty cards, detecting the compatibility of a barcode scanner with a virtual representation of a bar-code enabled card, and for location-aware handling of virtual cards. A system configured to practice the first method outputs a template of an expected size, and presents, within the template, a real-time image, obtained via a camera, of a card having a barcode. The system takes a picture of the card and, based on a card-template size relationship, extracts an image of the barcode. A system practicing the second method outputs a stored card image for a barcode scanner, and monitors an image feed of the bar code scanner scanning the display. If an associated scanner class indicates that the barcode scanner is unable to scan the stored image of the card, the system generates an alert.

### RELATED APPLICATIONS

This application claims priority to U.S. Provisional Application 61/504,720, filed on 6 Jul. 2011, the contents of which are herein incorporated by reference in their entirety.

### BACKGROUND

1. Technical Field

The present disclosure relates to bar code enabled cards and more specifically to automatic management of electronic copies of bar code enabled cards.

2. Introduction

Many merchants provide loyalty cards in order to reward consumer loyalty and return patronage and/or to track consumer behavior. For example, grocery stores like Safeway and Giant offer optional loyalty cards accompanied with incentives for card holders, such as discounts or free merchandise. Other members-only stores, such as Costco and Sams Club, require membership cards for entry and for purchases.

As a result, consumers are overwhelmed with these membership and loyalty cards, necessitating a large, heavy purse, wallet, or pocketbook. Further, consumers encounter problems when these cards are lost, forgotten at home, and so forth. What is needed in the art is a way to improve the consumer's management of such membership and loyalty cards.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for acquiring images of loyalty, membership, or other cards having bar codes. A system configured to practice the method outputs on a display of a mobile device, a template of an expected size. Then the system presents, within the template, a real-time image, obtained via a camera, of a card having a bar code. The system takes a picture of the card. Based on a size relationship between the picture of the card and the template, the system extracts an image of the bar code from the picture.

The system can also normalize the image of the bar code. The system can optionally identify a card type associated with the card, and store the picture of the card and the image of the bar code in a database according to the card type. The system can receive from a user a selection of the card, and output the picture of the card on the display according to the size relationship so that a bar code scanner is able to scan the display and extract information encoded in the bar code. The system can prompt the user to take a second picture of a reverse side of the card. The system can receive from a user additional information associated with the card, and store the additional information as metadata with the picture of the card.

Disclosed are systems, methods, and non-transitory computer-readable storage media for detecting the abilities of a bar code scanner to read a virtual representation of a bar code and prompt the user to act accordingly if the bar code scanner is incompatible or incapable of reading the virtual representation of the bar code. A system configured to practice this method has a processor, a display, and a front-facing camera. The system receives a request to display a stored image of a card having a bar code and retrieves the stored image of the card. Then the system outputs, via the display, the stored image of the card. While outputting the stored image of the card, the system monitors an image feed from the front-facing camera to detect a bar code scanner scanning the display and an associated scanner class, and, if the associated scanner class indicates that the bar code scanner is unable to scan the stored image of the card, the system generates an alert. The alert can be a vibration alert, an audible alert, and/or a visual alert. The system can detect the associated scanner class based on a database of scanners, scanner capabilities, and/or distinguishing scanner features. The system can monitor the image feed by comparing the image feed to the distinguishing scanner features.

Disclosed are systems, methods, and non-transitory computer-readable storage media for location-aware processing of virtual representations of bar codes. A system configured to practice this method determines a location of the computing device. The system identifies a stored image of a card having a bar code out of a database of stored images of cards, wherein the card is associated with a merchant within a threshold distance of the location. Then the system displays the stored image of the card. The system can determine the location in response to a user request. The user request can be an active request or a passive request.

The system can further determine, based on the merchant, capabilities of bar code scanners at the location, and adjust how the stored image of the card is displayed based on the capabilities. If the capabilities indicate that the bar code scanners at the location are incapable of scanning the stored image, the system can notify a user to manually show the stored image of the card to a person at a point of sale of the merchant. The system can notify the user via vibration, audible output, and/or visual output.

The system can further identify a set of merchants within the threshold distance for each of which the database stores an associated stored image, display at least some of the set of merchants to a user. Then the system can retrieve from the user a selection of one merchant from the set of merchants, and identify the stored image of the card based on the selection. The system can identify, via a camera, a type of bar code scanner at the location, and update a device-local and/or network-based bar code scanner database based on the type and the location.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system embodiment;

FIG. 2 illustrates an example mobile device for displaying an electronic substitute for a bar code enabled card;

FIG. 3 illustrates the example mobile device being scanned by a bar code scanner;

FIG. 4 illustrates exemplary different types of bar code scanners;

FIG. 5 illustrates two example virtual bar code representations;

FIG. 6 illustrates example interfaces for browsing virtual bar code representations;

FIG. 7 illustrates an exemplary system for location-aware processing of bar codes;

FIG. 8 illustrates a first example method embodiment;

FIG. 9 illustrates a first example method embodiment;

FIG. 10 illustrates a first example method embodiment;

FIG. 11A illustrates a mobile device capturing an image of a bar code enabled card; and

FIG. 11B illustrates an example template on the mobile device for accurately sizing the image of the bar code enabled card.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

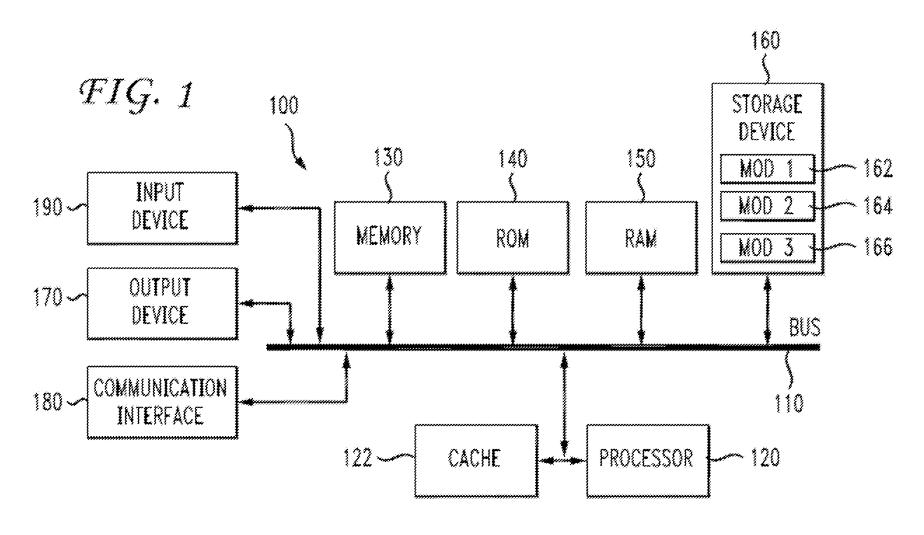

A system, method and non-transitory computer-readable media are disclosed which provide for improved management of loyalty, membership, and other bar code bearing objects. A brief introductory description of a basic general purpose system or computing device in FIG. 1 which can be employed to practice the concepts is disclosed herein. A more detailed description of the bar code approaches and variations thereof will then follow. The disclosure now turns to FIG. 1.

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

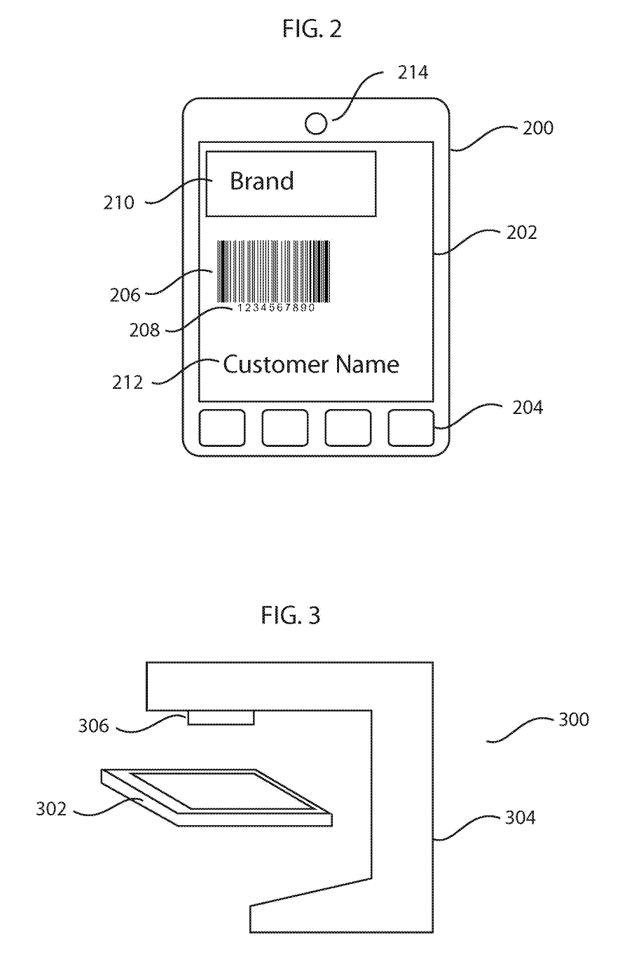

Having disclosed some components of a computing system, the disclosure now returns to a discussion of how to manage multiple items having bar codes in a more elegant manner. FIG. 2 illustrates an example mobile device 200 for displaying an electronic substitute for a bar code enabled card. The mobile device 200 can store information representing a set of different bar code enabled cards from different merchants. The information can be entered manually by a user, can be entered as image data, or can be populated by querying a server via an API. The mobile device 200 can display a virtual representation of a bar code enabled card (or at least a bar code portion of the card) on a display 202. The mobile device 200 can include various buttons 204 or other navigation or control input controls. The display 202 can include an image 206 of a bar code at a minimum. The display 202 can optionally include a number 208 associated with and/or represented by the bar code, a merchant or brand identifier 210, and/or a customer name 212. The mobile device 200 can also include a front-facing camera 214, a rear-facing camera, and/or any other type of camera.

Instead of the user presenting a bar code enabled loyalty card at a point of sale, the user can retrieve the corresponding loyalty card image on the mobile device 200, via a smartphone or tablet app for example, and the bar code scanner can scan the display of the mobile device 200. FIG. 3 illustrates a scenario 300 of an example mobile device 302 being scanned by a bar code scanner 304 having an image sensor 306. However, some types of bar code scanners may not be capable of reading the display of the mobile device. Further, certain types of bar code scanners may only be compatible with specific types of displays. To resolve this problem, the mobile device can detect a type of the bar code scanner, such as by examining an image of the bar code scanner via a front-facing camera, by determining a merchant location and matching that merchant location to a database of known scanner capabilities, based on user feedback, and so forth.

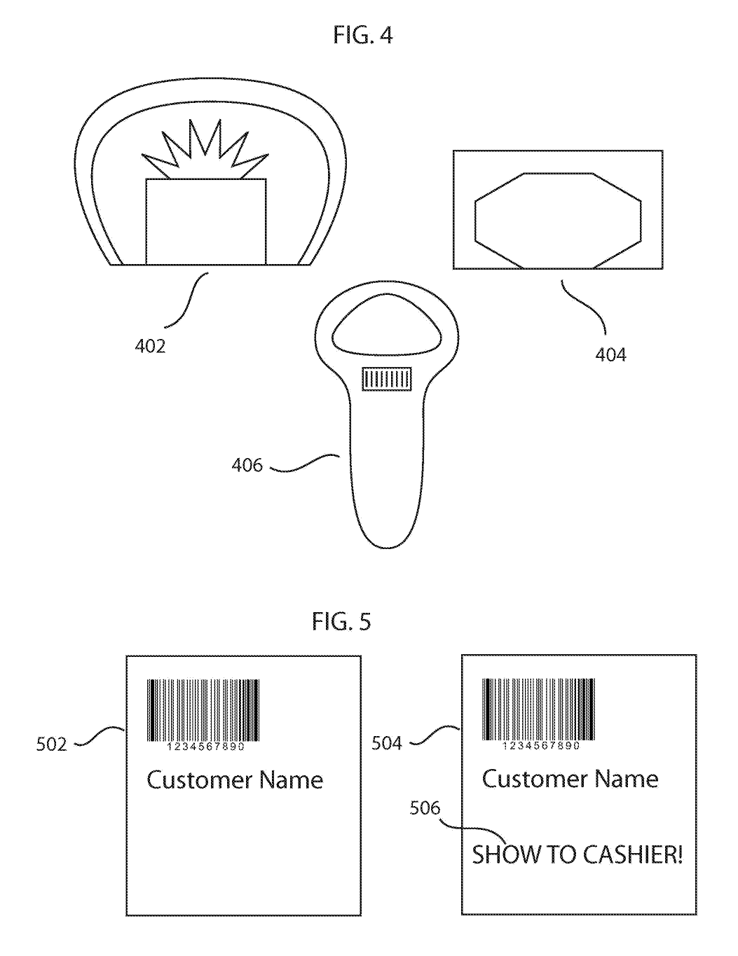

FIG. 4 illustrates exemplary different three different types 402, 404, 406 of bar code scanners from the perspective of a front-facing camera of a device being scanned. The device can detect identifying features of specific types of bar code scanners to determine if the bar code scanner is able to read the display of the device. If the device determines that the bar code scanner is able to read the display, the device continues displaying the bar code so that the scanner can read it. However, if the device determines that the bar code scanner is unable to read the display, or is likely to encounter more than a threshold level of difficulty or certainty in reading the bar code on the display, then the system can send an alert.

FIG. 5 illustrates two example virtual bar code representations. The first virtual bar code representation 502 illustrates what the device can display when the bar code scanner is able to read the bar code on the display. The second example virtual bar code representation 504 includes a visual alert 506 notifying the user to show the display to the cashier. The cashier can then look at the device and manually enter the account number associated with the bar code on the display. The device can also provide one or more other types of alerts alone or in conjunction with the visual alert 506, such as a noise, a vibration, a blinking LED, a text message, a modal or non-modal notification on the device, and/or other alerts on other surrounding devices external to the device.

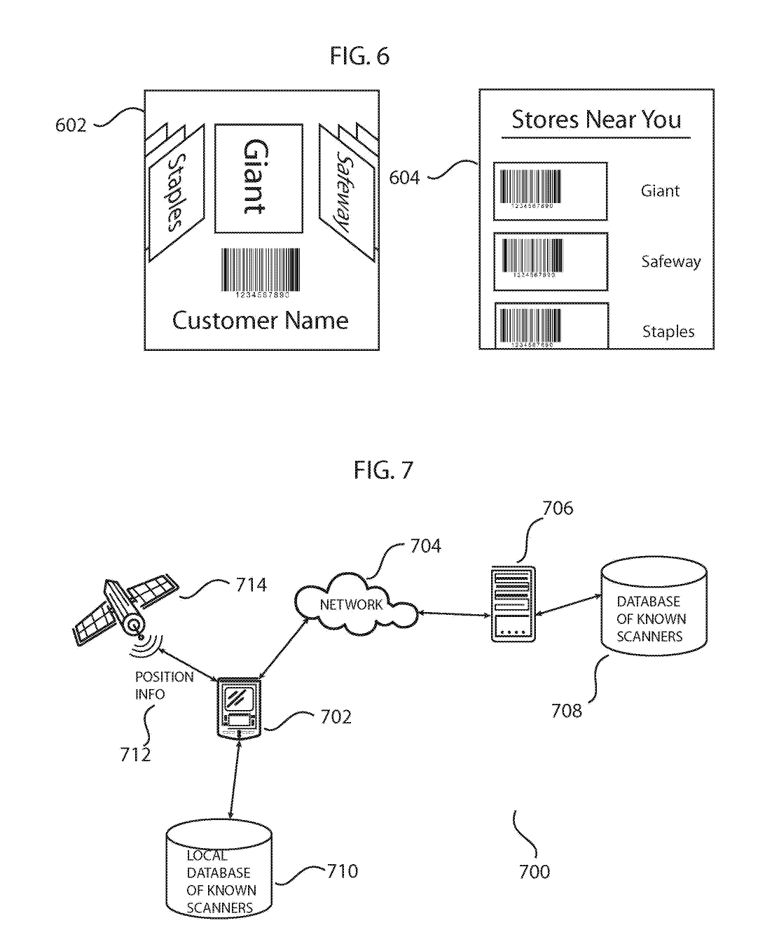

FIG. 6 illustrates example interfaces 602, 604 for browsing virtual bar code representations. The first example interface 602 shows one way that a user can browse through and manually select a stored virtual bar code representation from a database of stored virtual bar code representations. Other types of user interfaces for browsing the stored virtual bar code representations can be used. The second example interface 604 illustrates a location-aware approach. In this interface 604, the system detects a location of the device, compares that location to a set of available virtual bar code representations, and assembles a list of the top N closest ones, where N is a set number or where N is determined by a distance from the location based on a distance threshold. Either of these interfaces can also consider different types of data associated with the user and/or the device in order to determine which virtual bar code representations to suggest or show to the user. For example, if the system is a mobile phone with access to the user's calendar, the system can detect that the user has an appointment to go grocery shopping at the current time and then display first virtual bar code representations associated with grocery stores near the current location.

FIG. 7 illustrates an exemplary system 700 for location-aware processing of bar codes. The mobile device 702 can communicate via a network 704, such as the Internet and/or a cellular phone network, with a server 706. The server 706 can store a database of known scanners 708 that indicates scanner capabilities, locations, preferences, and so forth. The mobile device 702 can store a similar local database 710 of the same information or a subset of the information in the remote database 708, perhaps tailored to the stored cards in the mobile device 702 and/or locations in which the mobile device 702 frequently appears. When the mobile device 702 encounters a particular scanner at a particular location, indicated by position information 712 received via a positioning device 714 such as a satellite or cellular phone tower, the mobile device 702 can determine what types of scanners are available at that location and take action accordingly. For example, the mobile device 702 can load an application that retrieves the bar code image for that location automatically, or the mobile device 702 can modify how the bar code image is displayed based on the scanners' abilities at that location. Further, as the mobile device 702 encounters new or updated information, the mobile device 702 and the server 706 can coordinate to update one or both of the databases 708, 710.

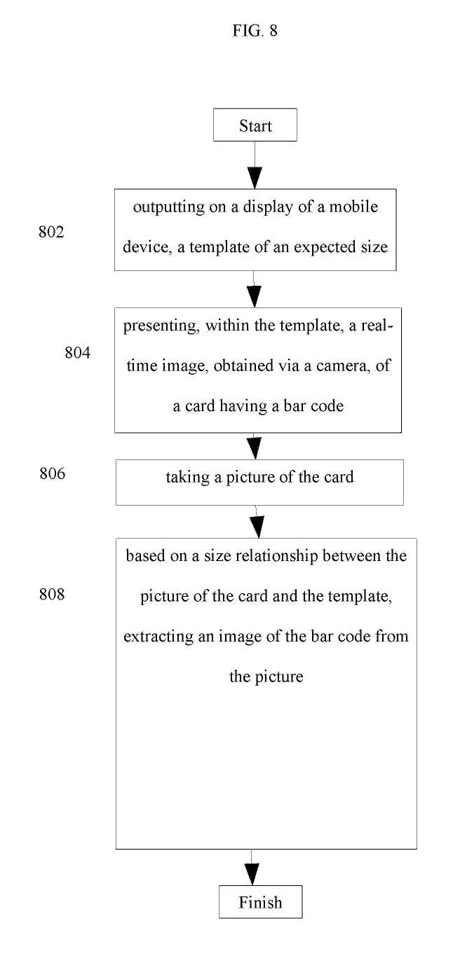

Having disclosed some basic system components and concepts, the disclosure now turns to the exemplary method embodiment shown in FIGS. 8-10. For the sake of clarity, the methods are discussed in terms of an exemplary system 100 as shown in FIG. 1 configured to practice the respective methods. The steps outlined herein are exemplary and can be implemented in any combination thereof, including combinations that exclude, add, or modify certain steps.

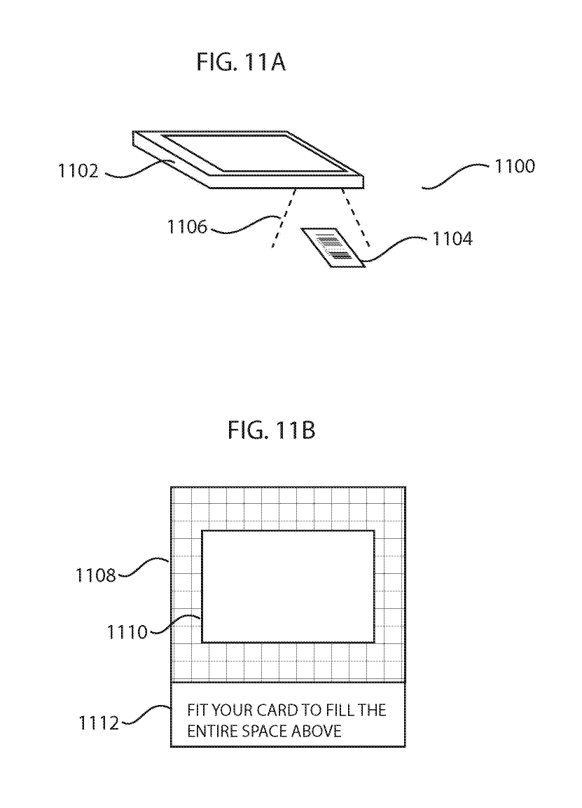

FIG. 8 illustrates a first example method embodiment for capturing an image of a bar code enabled card. The method of FIG. 8 is further illustrated by FIGS. 11A and 11B. A system 100 configured to practice the method outputs on a display of a mobile device, a template of an expected size (802). Then the system 100 presents, within the template, a real-time image, obtained via a camera, of a card having a bar code (804). The system 100 takes a picture of the card (806). Based on a size relationship between the picture of the card and the template, the system 100 extracts an image of the bar code from the picture (808). If the image is unacceptable, the system can prompt the user to take another picture of the card having the bar code, and can provide instructions and/or tips for correcting what was unacceptable about the original image.

The system 100 can also normalize the image of the bar code. The system 100 can optionally identify a card type associated with the card, and store the picture of the card and the image of the bar code in a database according to the card type. The system 100 can receive from a user a selection of the card, and output the picture of the card on the display according to the size relationship so that a bar code scanner is able to scan the display and extract information encoded in the bar code. The system 100 can prompt the user to take a second picture of a reverse side of the card. The system 100 can receive from a user additional information associated with the card, and store the additional information as metadata with the picture of the card.

FIG. 11A illustrates a mobile device 1102 capturing an image of a bar code enabled card 1104. The user places the bar code enabled card 1104 in the field of view 1106 of a camera of the mobile device. FIG. 11B illustrates an example template 1108 with a cutout 1110 or transparent field on the mobile device for accurately sizing the image of the bar code enabled card. The display can also include instructions 1112 to the user for how to use the template. Then, as the user positions the bar code enabled card 1104 in the field of view 1106, the display of the mobile device 1102 updates to show a substantially real time preview to the user. When the user is pleased with the placement of the bar code enabled card 1104, the user can take the picture.

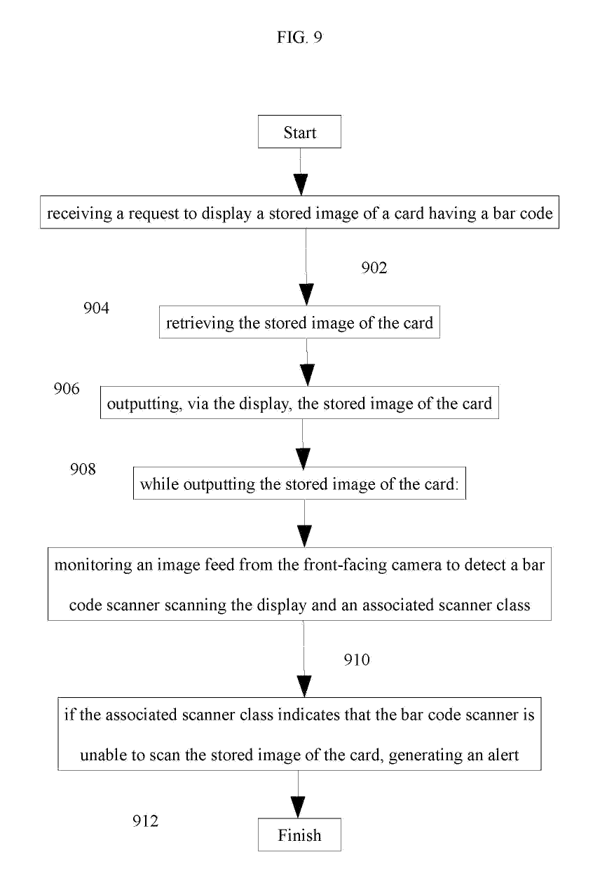

FIG. 9 illustrates a first example method embodiment for detecting whether a bar code scanner is able to read the virtual representation of the bar code enabled card. A system 100 configured to practice this method has a processor, a display, and a front-facing camera. The system 100 receives a request to display a stored image of a card having a bar code (902) and retrieves the stored image of the card (904). Then the system 100 outputs, via the display, the stored image of the card (906). While outputting the stored image of the card (908), the system 100 monitors an image feed from the front-facing camera to detect a bar code scanner scanning the display and an associated scanner class (910), and, if the associated scanner class indicates that the bar code scanner is unable to scan the stored image of the card, the system 100 generates an alert (912). The alert can be a vibration alert, an audible alert, and/or a visual alert. The system can detect the associated scanner class based on a database of scanners, scanner capabilities, and/or distinguishing scanner features. The system can monitor the image feed by comparing the image feed to the distinguishing scanner features.

The system 100 can prompt the user for feedback on a particular type of bar code scanner, such as whether the scanner worked properly or not. Then the system can store that feedback, along with a stored image of the scanner and any other related information in a database for later use.

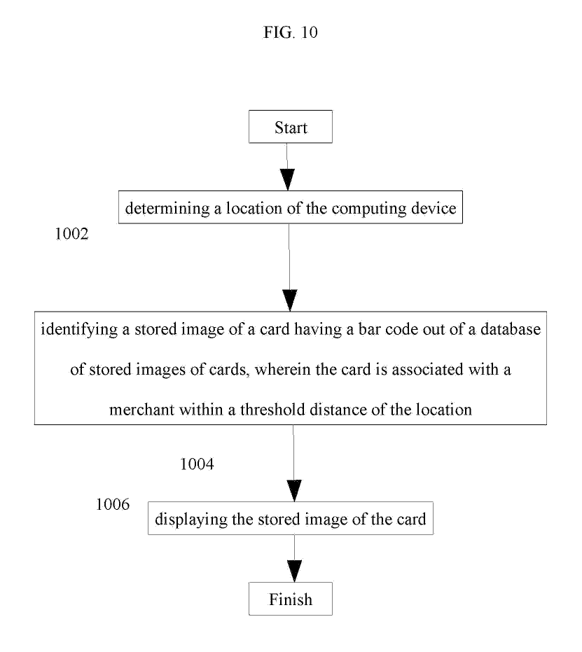

FIG. 10 illustrates a third example method embodiment for location-aware virtual representations of bar code enabled cards. A system 100 configured to practice this method determines a location of the system (1002). For example, the system can be a mobile device and can determine its location by one or more of GPS, cell phone signal triangulation, local wifi network availability, and so forth. The system 100 identifies a stored image of a card having a bar code out of a database of stored images of cards, wherein the card is associated with a merchant within a threshold distance of the location (1004). Then the system 100 displays the stored image of the card (1006). The system 100 can determine the location in response to a user request. The user request can be an active request or a passive request.

The system 100 can further determine, based on the merchant, capabilities of bar code scanners at the location, and adjust how the stored image of the card is displayed based on the capabilities. If the capabilities indicate that the bar code scanners at the location are incapable of scanning the stored image, the system 100 can notify a user to manually show the stored image of the card to a person at a point of sale of the merchant. The system 100 can notify the user via vibration, audible output, and/or visual output.

The system 100 can further identify a set of merchants within the threshold distance for each of which the database stores an associated stored image, display at least some of the set of merchants to a user. Then the system 100 can retrieve from the user a selection of one merchant from the set of merchants, and identify the stored image of the card based on the selection. The system 100 can identify, via a camera, a type of bar code scanner at the location, and update a device-local and/or network-based bar code scanner database based on the type and the location.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein are applicable to any object that holds a bar code, such as key chains, books and other media, toys, and so forth. Those skilled in the art will readily recognize various modifications and changes that may be made to the principles described herein without following the example embodiments and applications illustrated and described herein, and without departing from the spirit and scope of the disclosure.

We claim:

1. A method comprising:
outputting on a display of a mobile device, a template of an expected size;
presenting, within the template, a real-time image, obtained via a camera, of a card having a bar code;
taking a picture of the card; and
based on a size relationship between the picture of the card and the template, extracting an image of the bar code from the picture.

2. The method of claim 1, further comprising normalizing the image of the bar code.

3. The method of claim 1, further comprising:
identifying a card type associated with the card; and
storing the picture of the card and the image of the bar code in a database according to the card type.

4. The method of claim 1, further comprising:
receiving from a user a selection of the card; and
outputting the picture of the card on the display according to the size relationship so that a bar code scanner is able to scan the display and extract information encoded in the bar code.

5. The method of claim 1, further comprising:
taking a second picture of a reverse side of the card.

6. The method of claim 1, further comprising:
receiving from a user additional information associated with the card; and
storing the additional information as metadata with the picture of the card.

7. A system comprising:
a processor;
a display;
a front-facing camera;
a memory storing instructions for controlling the processor to perform steps comprising:
receiving a request to display a stored image of a card having a bar code;
retrieving the stored image of the card;
outputting, via the display, the stored image of the card;
while outputting the stored image of the card:
monitoring an image feed from the front-facing camera to detect a bar code scanner scanning the display and an associated scanner class; and
if the associated scanner class indicates that the bar code scanner is unable to scan the stored image of the card, generating an alert.

8. The system of claim 7, wherein the alert is at least one of a vibration alert, an audible alert, and a visual alert.

9. The system of claim 7, wherein detecting the associated scanner class is based on a database of scanners, scanner capabilities, and distinguishing scanner features.

10. The system of claim 9, wherein monitoring the image feed further comprises comparing the image feed to the distinguishing scanner features.

11. A non-transitory computer-readable storage medium storing instructions which, when executed by a computing device, cause the computing device to perform steps comprising:
determining a location of the computing device;
identifying a stored image of a card having a bar code out of a database of stored images of cards, wherein the card is associated with a merchant within a threshold distance of the location;
displaying the stored image of the card.

12. The non-transitory computer-readable storage medium of claim 11, wherein determining the location of the computing device is performed in response to a user request.

13. The non-transitory computer-readable storage medium of claim 12, wherein the user request is one of an active request and a passive request.

14. The non-transitory computer-readable storage medium of claim 11, the instructions further comprising:
determining, based on the merchant, capabilities of bar code scanners at the location; and
adjusting how the stored image of the card is displayed based on the capabilities.

15. The non-transitory computer-readable storage medium of claim 14, wherein if the capabilities indicate that the bar code scanners at the location are incapable of scanning the stored image, the instructions further comprise:
notifying a user to manually show the stored image of the card to a person at a point of sale of the merchant.

16. The non-transitory computer-readable storage medium of claim 15, wherein notifying the user comprises at least one of vibration, audible output, and a visual output.

17. The non-transitory computer-readable storage medium of claim 11, the instructions further comprising:
identifying a set of merchants within the threshold distance for each of which the database stores an associated stored image;
displaying at least some of the set of merchants to a user;
retrieving from the user a selection of one merchant from the set of merchants; and
identifying the stored image of the card based on the selection.

18. The non-transitory computer-readable storage medium of claim 11, the instructions further comprising:
identifying, via a camera, a type of bar code scanner at the location.

19. The non-transitory computer-readable storage medium of claim 18, the instructions further comprising:
updating a bar code scanner database based on the type and the location.

20. The non-transitory computer-readable storage medium of claim 11, wherein the database of stored images of cards is a device-local database.
